(19) United States
(12) Patent Application Publication
(10) Pub. No.: US 2016/0283794 A1
(43) Pub. Date: Sep. 29, 2016

(54) Augmented Reality Marker

(71) Applicant: HEWLETT PACKARD ENTERPRISE DEVELOPMENT LP, Houston, TX (US)

(72) Inventor: Jeremy Edward Kark Barribeau, Vancouver, WA (US)

(73) Assignee: HEWLETT PACKARD ENTERPRISE DEVELOPMENT LP, Houston, TX (US)

(21) Appl. No.: 15/033,509

(22) PCT Filed: Nov. 12, 2013
(86) PCT No.: PCT/US13/69754

§ 371 Date: Apr. 29, 2016

(51) Int. Cl. G06K 9/00; G06T 19/00; G06K 9/20

(52) U.S. Cl. CPC G06K 9/00671; G06K 9/2063; G06K 9/2018; G06T 19/006; G06T 2219/004

(57) ABSTRACT

An object is marked for detection by an augmented reality system. The object comprises an invisible light source to produce an augmented reality maker. The invisible light source is embedded in a material or positioned behind a wall. At least a portion of the wall or material is transparent to the invisible light produced by the invisible light source, but opaque to visible light.

### BACKGROUND

Augmented reality is a technology in which a view of the real physical world is augmented by computer generated information. For example, a view of an environment through a pair of glasses, a monitor, or video camera, may be augmented with text, symbols or graphics etc providing further information about objects in the environment. The augmented reality system may recognize objects and match the recognized objects with data in a computer database, or the like, and computer generated information about the objects may be displayed together with the object in the augmented reality view.

Augmented reality markers may be painted or printed onto the objects in order to help the augmented reality system recognize the objects. The augmented reality markers may for example comprise a plurality of dots, a pattern or other distinctive marking. Different objects may have different markers so that an augmented reality system can recognize different objects by their unique markers.

### BRIEF DESCRIPTION OF THE DRAWINGS

Examples of the invention will now be described, by way of non-limiting example only, with reference to the accompanying drawings, in which:

FIG. 1A shows an example of an object with an augmented reality marker according the present disclosure as seen by an augmented reality system;

FIG. 1B shows the object of FIG. 1A as seen by the human eye;

FIG. 2 shows an example an example configuration for producing the augmented reality marker;

FIG. 3 shows another example configuration for producing the augmented reality marker;

FIG. 4 shows another example configuration for producing the augmented reality marker; and

FIG. 5 shows an example of an augmented reality system.

### DETAILED DESCRIPTION

Throughout the present disclosure, the terms “a” and “an” are intended to denote at least one of a particular element. As used herein, the term “includes” means includes but not limited to, the term “including” means including but not limited to. The term “based on” means based at least in part on.

As mentioned above, marking a surface of an object with an augmented reality maker helps a camera in an augmented reality system to identify the object more easily. In some cases the augmented reality marker may also help the augmented reality system to determine the orientation of the object. Typically the augmented reality marker my be printed or painted by ink. However, this may spoil the appearance of the object.

Accordingly one example of the present disclosure proposes that the augmented reality maker is produced by an invisible light source, e.g. an infrared or ultraviolet light source, inside the object and that a wall of the object has at least a portion which is transparent to the invisible light and substantially opaque to visible light. In this way when a human observer views the object they cannot see the augmented reality marker. However, when an augmented reality system which is able to detect the invisible light views the object, it can see the augmented reality marker.

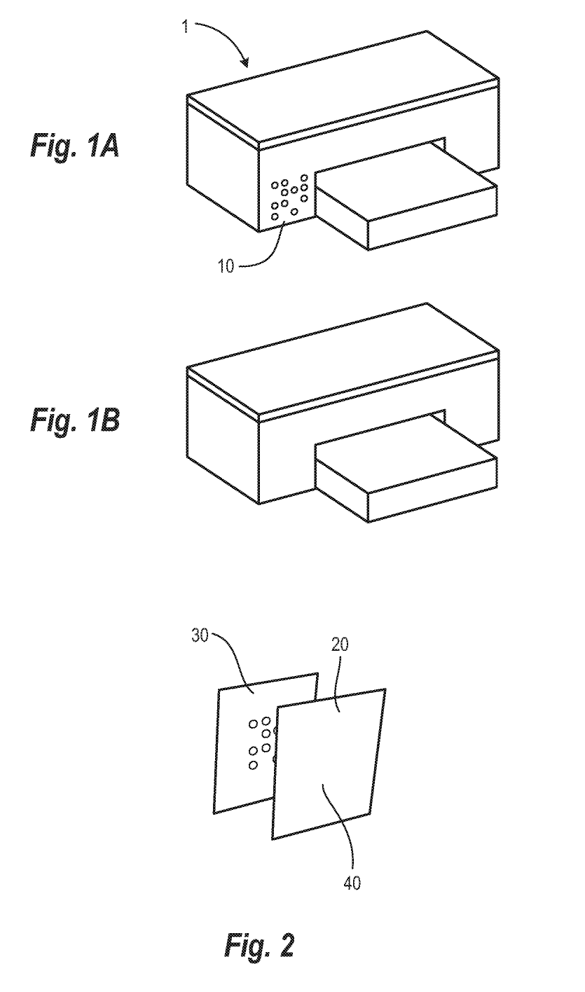

FIG. 1A shows an example of an object 1 which has an augmented reality marker 10 produced by light in the non-visible spectrum FIG. 1A shows the object as seen by an augmented reality system which can detect the invisible light. FIG. 1B shows the same object as seen by the human eye which cannot see the augmented reality marker produced by invisible light.

For the purposes of this disclosure visible light is defined as light which is visible by the naked human eye, e.g. light having a wavelength of 400 to 700 nm. Invisible light is light which is not visible to the naked human eye, e.g. having a wavelength below 400 nm or above 700 nm. In one example the invisible light is infrared light, e.g. light having a wavelength of 750 to 25 μm. In one example the invisible light is in the near or mid infrared spectrum, e.g. light having a wavelength of 780 nm to 5000 nm in one example the invisible light is in the near infrared spectrum, e.g. light having a wavelength of 800 nm to 1440 nm. In another example the invisible light is light having a wavelength of 800 nm to 1100 nm. In other examples the invisible light may be ultraviolet light, e.g. light having a wavelength of 10 nm to 380 nm. Infrared light will be referred to in the following examples, but it is to be understood that the teachings of this disclosure may be implemented with other types of invisible light. For example ultraviolet light sources and detectors may be used instead.

In FIGS. 1A and 1B the example object is a printer. When an augmented reality system detects the printer it may display the printer together with extra information pertaining to the printer—e.g. its printer name, model, IP address or ink levels. However, the present disclosure is not limited to printers or office equipment and they are given as just one example of objects which may be marked for detection by an augmented reality system.

FIG. 2 shows an example of one way in which the augmented reality marker may be provided. A plurality of infrared light sources 30 are provided inside the object. For example the infrared light sources may be infrared Light Emitting Diodes (LEDs) or normal visible light sources which also emit infrared light etc. The plurality of infrared light sources 30 are arranged in a pattern which may be recognized by a detector as an augmented reality marker identifying the object. The infrared light sources may for instance be mounted on a panel 20 or other internal part of the object. In another example there may be a single infrared light source having a shape corresponding to an augmented reality marker. A wall, such as panel 40, is positioned in front of the infrared light sources. The wall 40 may be an external wall of the object, for example part of the object's casing. The wall 40 is substantially opaque to visible light so the human eye cannot see the interior of the object and the infrared light sources etc. This helps to maintain the aesthetic appearance of the object. However, the wall is transparent to infrared light, so the augmented reality marker 10 formed by the infrared light sources may be detected by an infrared detector and recognized by the augmented reality system. The term “infrared detector” is intended to include any electrical or electronic device which is capable of detecting infrared light. It includes conventional digital cameras as well as more specialized infrared detecting equipment. Many digital cameras are able to detect light having wavelengths in the range 400 nm to 1100 nm and so may act as infrared detectors.

The wall 40 may comprise any of various types of material which have the property of being substantially opaque to visible light and transparent to infrared light. For example, the wall may comprise a polymer. In some examples the wall may comprise a polycarbonate, polystyrene, PMMA (Poly(methyl methacrylate)) or acrylic material to which a colorant is added. The polycarbonate, polystyrene, RMMA or acrylic material may be naturally transparent to visible and infrared light, while the colorant may be opaque to visible light, but transparent to infrared light. The colorant may be a die or pigment etc. In another example the wall may comprise a germanium, silicon, or silicone, based material which is opaque to visible light and transparent to infrared light. The whole wall may be transparent to infrared light or only a portion of the wall may be transparent to infrared light as long as the augmented reality marker can be seen through the infrared transparent portion.

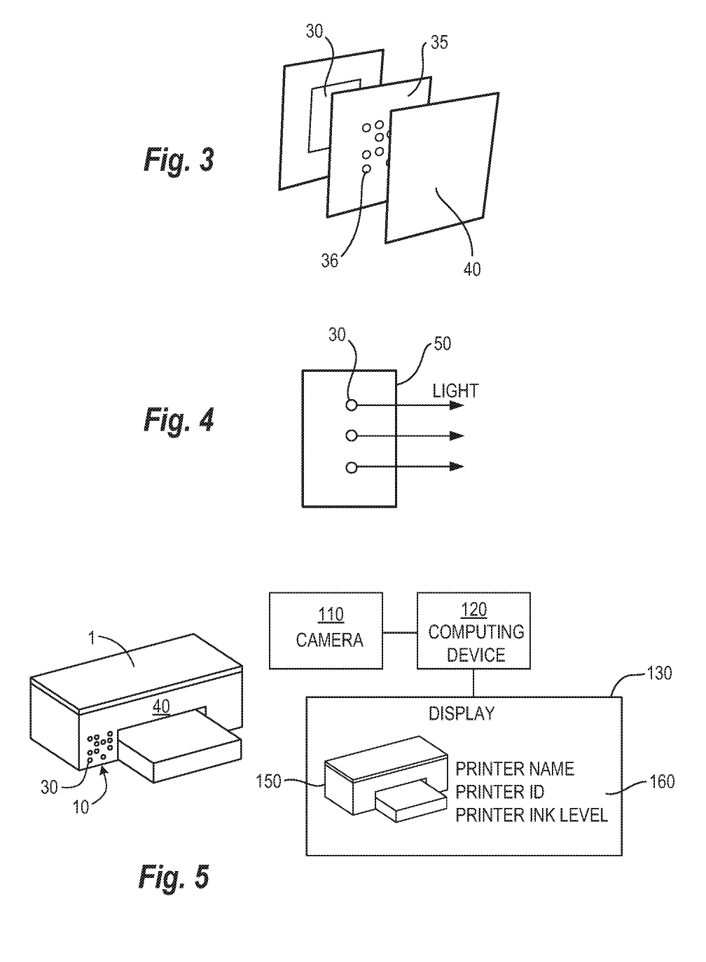

FIG. 3 shows another example in which the augmented reality marker is formed from an infrared light source 30 in combination with a filter 35. The filter 35 lets through only a part of the infrared light, while filtering out the rest, in a manner which creates a pattern forming the augmented reality marker. In the illustrated example the filter 35 has a pattern of infrared transparent portions or holes 36 which let through infrared light. The infrared light which makes it through thus forms a pattern corresponding to an augmented reality marker. As in the previous example, a wall 40 of the object has at least a portion which is transparent to infrared light and opaque to visible light. The wall 40 thus allows an infrared detector to detect the augmented reality marker while hiding the interior of the object from the naked human eye.

FIG. 4 shows a further example in which a plurality of infrared light sources 30 are embedded in a material 50 which is transparent to infrared light and opaque to visible light. The material 50 may for example be an external wall of an object. The plurality of infrared light sources 30 project an augmented reality marker through the material 50 and detected by an infrared detector. In variations a single embedded infrared light source may have a shape corresponding to an augmented reality marker or a filter may be used to form the pattern of light from the embedded infrared light source as described above.

In the examples above the invisible light source may have an on or off switch, or may be configured to always be on or on in certain circumstances. If the object is a piece of electronic equipment then the invisible light source may be configured to be always on, on when the object is operational or on when the object is operational or in a sleep mode. The invisible light source may have its own power source, such as a battery. In other examples the invisible light source may draw power from a power source of the object, for instance from a power supply circuit if the object is a piece of electrical or electronic equipment.

FIG. 5 is a schematic diagram which shows an example augmented reality system. The augmented reality system comprises a camera 110, a computing device 120 and a display 130. Also shown in FIG. 5 is an object 1 in the environment monitored by the augmented reality system. The object 1 is marked for detection by the augmented reality system and comprises an augmented reality marker 10 produced by infrared light as discussed in the examples above.

The augmented reality system captures an image of real physical world, including object 1, with the camera 110 and displays the image on the display 130. This image of the real world is typically formed from visible light. As many digital cameras are able to detect both visible and infrared light, the camera 110 may also be able to act as an infrared detector to detect the augmented reality marker. Thus in some implementations it may be possible for the augmented reality system to use a conventional digital camera with little or no modification.

In some cases the digital camera may have an infrared filter to block infrared light. If such an infrared filter is present, then depending on the filter's effectiveness in filtering out infrared light and depending on the wavelengths it filters compared to the wavelengths used by the infrared light source, the infrared filter may need to be turned off, removed or moved out of the optical path between the lens and image sensor so that infrared light can be detected by the camera. The infrared filter may for example be moved out of the optical path by selecting a camera mode which does not use the infrared filter, or it may be permanently physically removed from the camera. In one example a camera may be configured to alternate between using an infrared filter and not using an infrared filter, so that the camera can form visible light images without infrared interference for sending to the display and also detect any infrared augmented reality marker. In other examples the infrared filter may filter out only longer wavelengths and still allow through sufficient infrared light in the near infrared spectrum to allow the augmented reality marker to be detected.

In still other examples a separate infrared detector may be employed and for example mounted on the camera. The separate infrared detector in this case may be another camera without an infrared filter or with the infrared filter turned off, or a dedicated device for detecting infrared light.

As an infrared light source is inside the object, it is not necessary for the augmented reality system to project infrared light onto the object in order to detect the augmented reality marker.

Infrared light detected by the camera 110 or a separate infrared detector (if any) may be sent to the computing device 120 for analysis. If the computing device recognizes an augmented reality marker 10 from the infrared light it may use it to identify the object 1. For example the augmented reality marker may be referenced with a database of known objects and corresponding augmented reality markers. The computing device 120 may further obtain or generate information 160 relating to the recognized object and display some or all of the information 160 on the display 130 together with real world image 150 of the object. For example the information may identify the object and some of its characteristics and be displayed as computer generated text, 2 or 3D graphics, symbols, animation or video etc next to the object or overlaid on the object. In some examples the augmented reality marker itself may be displayed on the display together with the real world image from the visible light. In other examples the augmented reality marker is not displayed on the display although it is detected by the augmented reality system.

While the camera, computing device and display of the augmented reality system is shown as separate parts in FIG. 5 for clarity, they may be combined into a single device such as camera, mobile phone, tablet computer or computerized glasses etc. The computing device 120 may access the internet, a server, a private network or the cloud to match a detected augmented reality marker with an object and/or to obtain information about a recognized object.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An object that is marked for detection by an augmented reality system, the object comprising a wall and an infrared light source arranged to produce an augmented reality marker; at least a portion of the wall being substantially opaque to visible light and allowing infrared light to pass so that the augmented reality marker can be detected by an infrared detector.

2. The object of claim 1 wherein comprises silicon, silicone or germanium.

3. The object of claim 1 wherein the wall comprises a polycarbonate, polystyrene, Poly(methyl methacrylate) or acrylic material to which a colorant is added.

4. The object of claim 1 wherein the wall comprises a material which is ordinarily transparent to visible and infrared light, but to which a colorant has been applied to cause it to become opaque to visible light.

5. The object of claim 1 wherein the object comprises a plurality of infrared light sources arranged to produce a pattern which acts as an augmented reality marker.

6. The object of claim 1 wherein the object comprises an infrared light source having a shape corresponding to an augmented reality marker.

7. The object of claim 1 wherein the object comprises a light source in combination with a filter; the filter acting in combination with the infrared light source to produce a pattern which acts as an augmented reality marker.

8. An object that is marked for detection by an augmented reality system, the object comprising
a material which is substantially opaque to visible light and which allows the invisible light to pass and an invisible light source embedded in said material and arranged to produce an augmented reality fiduciary marker which is detectable by an invisible light detector.

9. The object of claim 8 wherein the invisible light has a wavelength of between 780 and 1440 nm.

10. The object of claim 8 wherein the material comprises a polycarbonate, polystyrene, Poly(methyl methacrylate) or acrylic to which a colorant is added.

11. The object of claim 8 wherein the material is ordinarily transparent to visible light, but a colorant has been applied to the material to cause it to become opaque to visible light.

12. A method of marking an object for detection by an augmented reality system comprising embedding the infrared light source inside a material which is substantially opaque to visible light but transparent to infrared light, or placing the infrared light source behind a panel wherein at least a portion of the panel is substantially opaque to visible light but transparent to infrared light.

13. The method of claim 12 wherein the material comprises silicon, silicone or germanium.

14. The method of claim 12 wherein the material comprises a transparent polycarbonate, polystyrene, Poly(methyl methacrylate) or acrylic material to which a colorant is added.

15. The method of claim 12 comprising providing a plurality of infrared light sources, or a light source in combination with a filter, to produce a pattern which acts as an augmented reality marker.
